(19) United States
(12) Patent Application Publication
(10) Pub. No.: US 2025/0018968 A1
(43) Pub. Date: Jan. 16, 2025

(54) DRIVER MONITORING DEVICE, DRIVER MONITORING METHOD AND DRIVER MONITORING COMPUTER PROGRAM

(71) Applicants: TOYOTA JIDOSHA KABUSHIKI KAISHA, Toyota-shi (JP); DENSO CORPORATION, Kariya-city (JP)

(72) Inventor: Masataka Sano, Tokyo-to (JP)

(73) Assignees: TOYOTA JIDOSHA KABUSHIKI KAISHA, Toyota-shi (JP); DENSO CORPORATION, Kariya-city (JP)

(21) Appl. No.: 18/736,919

(22) Filed: Jun. 7, 2024

(30) Foreign Application Priority Data
Jul. 14, 2023 (JP) 2023-116084

(51) Int. Cl. B60W 50/14; B60W 40/08; G06V 20/58; G06V 20/59

(52) U.S. Cl. CPC B60W 50/14; B60W 40/08; G06V 20/58; G06V 20/597; B60W 2540/225

(57) ABSTRACT

The driver monitoring device includes a processor configured to: detect an object having a possibility of affecting traveling of a vehicle based on an external sensor signal, detect, among a gaze direction of a driver of the vehicle and an orientation of a face of the driver, at least the gaze direction based on a driver image, determine whether an object direction to the detected object is included within a peripheral visual range corresponding to a peripheral visual field of the driver based on the gaze direction, set an inattentiveness warning condition when the object direction is included within the peripheral visual range based on a driving mode or the situation around the vehicle, and notify the driver of an inattentiveness warning via a notification device when at least detected one of the orientation of the face and the gaze direction satisfies the inattentiveness warning condition.

### FIELD

The present invention relates to a driver monitoring device, a driver monitoring method, and a driver monitoring computer program for monitoring a driver of a vehicle.

### BACKGROUND

A technique for detecting inattentiveness on the part of a driver has been proposed (see Japanese Unexamined Patent Publication JP2009-15550A).

### SUMMARY

A driver of a vehicle may not face a traveling direction of the vehicle due to some reason after understanding the situation around the vehicle. If an inattentiveness warning is indicated in such a case, this may irritate the driver.

Therefore, an object of the present invention is to provide a driver monitoring device capable of appropriately executing an inattentiveness warning to a driver.

According to one embodiment, a driver monitoring device is provided, which includes a processor configured to: detect an object having a possibility of affecting traveling of a vehicle based on an external sensor signal representing a situation around the vehicle, detect, among a gaze direction of a driver of the vehicle and an orientation of a face of the driver, at least the gaze direction based on a driver image representing the driver, determine whether or not an object direction to the detected object is included within a peripheral visual range corresponding to a peripheral visual field of the driver based on the gaze direction set an inattentiveness warning condition when the object direction is included within the peripheral visual range based on a driving mode being applied to the vehicle or the situation around the vehicle, and notify the driver of an inattentiveness warning via a notification device when at least detected one of the orientation of the face of the driver and the gaze direction of the driver satisfies the inattentiveness warning condition.

In one embodiment, the processor sets the inattentiveness warning condition in a case where the driving mode is set to a first driving mode in which the driver is not required to hold a steering, to be stricter than the inattentiveness warning condition in a case where the driving mode is set to a second driving mode in which the driver is required to hold the steering.

In one embodiment, in the case where the driving mode is set to a first driving mode in which the driver is not required to hold a steering, the processor sets the inattentiveness warning condition when the object direction is included within the peripheral visual range stricter than the inattentiveness warning condition when the object direction is not included within the peripheral visual range.

In one embodiment, the processor is further configured to determine whether or not the detected object is moving, and the processor sets the inattentiveness warning condition when the detected object is stationary stricter than the inattentiveness warning condition when the detected object is moving, in a case where the driving mode is set to a first driving mode in which the driver is not required to hold a steering and the object direction is included within the peripheral visual range.

According to another embodiment, a driver monitoring method is provided. The driver monitoring method includes: detecting an object having a possibility of affecting traveling of a vehicle based on an external sensor signal representing a situation around the vehicle; detecting, among a gaze direction of a driver of the vehicle and an orientation of a face of the driver, at least the gaze direction based on a driver image representing the driver; determining whether or not an object direction to the detected object is included within a peripheral visual range corresponding to a peripheral visual field of the driver based on the gaze direction; setting an inattentiveness warning condition when the object direction is included within the peripheral visual range based on a driving mode being applied to the vehicle or the situation around the vehicle; and notifying the driver of an inattentiveness warning via a notification device when at least detected one of the orientation of the face of the driver and the gaze direction of the driver satisfies the inattentiveness warning condition.

According to still another embodiment, a non-transitory recording medium that stores a driver monitoring computer program is provided. The driver monitoring computer program includes instructions causing a processor mounted on a vehicle to execute a process including: detecting an object having a possibility of affecting traveling of a vehicle based on an external sensor signal representing a situation around the vehicle; detecting, among a gaze direction of a driver of the vehicle and an orientation of a face of the driver, at least the gaze direction based on a driver image representing the driver; determining whether or not an object direction to the detected object is included within a peripheral visual range corresponding to a peripheral visual field of the driver based on the gaze direction; setting an inattentiveness warning condition when the object direction is included within the peripheral visual range based on a driving mode being applied to the vehicle or the situation around the vehicle; and notifying the driver of an inattentiveness warning via a notification device when at least detected one of the orientation of the face of the driver and the gaze direction of the driver satisfies the inattentiveness warning condition.

The driver monitoring device according to the present disclosure has an advantageous effect of being able to appropriately execute an inattentiveness warning to a driver.

### BRIEF DESCRIPTION OF DRAWINGS

FIG. 1 schematically illustrates the configuration of a vehicle control system including a driver monitoring device.

FIG. 2 illustrates the hardware configuration of an ECU, which is an example of the driver monitoring device.

FIG. 3 is a functional block diagram of a processor of ECU.

FIG. 4A illustrates an example of an inattentiveness warning condition.

FIG. 4B illustrates another example of the inattentiveness warning condition.

FIG. 5 is an operation flowchart of the driver monitoring process.

### DESCRIPTION OF EMBODIMENTS

Hereinafter, a driver monitoring device, a driver monitoring method executed by the driver monitoring device, and a driver monitoring computer program will be described with reference to the attached drawings. The driver monitoring device sets a condition of an inattentiveness warning when an object having a possibility of affecting traveling of a vehicle is included within a peripheral visual field of the driver, in accordance with a driving mode being applied to the vehicle or a condition around the vehicle. In the present embodiment, the “inattentive view” refers to a state in which the driver does not monitor the front direction of the vehicle, i.e., the traveling direction of the vehicle when the vehicle is moving forward.

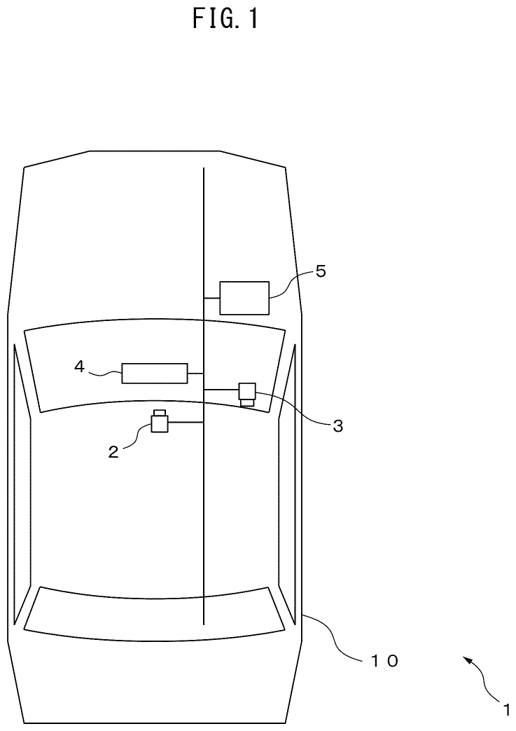

FIG. 1 schematically illustrates the configuration of a vehicle control system including a driver monitoring device. In the present embodiment, the vehicle control system 1, which is mounted on a vehicle 10 and controls the vehicle 10, includes at least one external sensor 2, a driver monitoring camera 3, a notification device 4, and an electronic control unit (ECU) 5, which is an example of the driver monitoring device. The external sensor 2, the driver monitoring camera 3, the notification device 4, and the ECU 5 are communicably connected to each other.

The external sensor 2 is a sensor for detecting a situation around the vehicle 10, and is, for example, a camera or a ranging sensor such as a radar, or a LiDAR. It should be noted that the vehicle 10 may be provided with a plurality of external sensors having different detection ranges or different types. The external sensor 2 generates an external sensor signal representing a situation of a predetermined region around the vehicle 10, such as a front region of the vehicle 10, every predetermined period, and outputs the generated external sensor signal to the ECU 5.

The driver monitoring camera 3 is an example of an interior sensor, and is mounted toward the driver at or near the instrument panel so that the head of the driver seated on the driver seat of the vehicle 10 is included in the imaging target area. The driver monitoring camera 3 may include a light source such as an infrared LED. The driver monitoring camera 3 takes a picture of the driver to generate an image representing the driver (hereinafter referred to as a driver image) every predetermined capturing period, and outputs the generated driver image to the ECU 5.

The notification device 4 is provided in the vehicle interior of the vehicle 10, and is a device that gives a predetermined notification to the driver by light, sound, vibration, character display, or image display. For this purpose, the notification device 4 includes, for example, at least one of a speaker, a light source, a vibrator, and a display device. When the notification device 4 receives a notice representing a warning from the ECU 5 to the driver, it notifies the driver of the warning by the voice from the speaker, the light emitting or flashing of the light source, vibration of the vibrator, or displaying a warning message on the display device.

The ECU 5 controls autonomous driving of the vehicle 10 or supports driving of the driver of the vehicle 10 according to an applied driving mode. Further, the ECU 5 notifies the driver of the inattentiveness warning via the notification device 4 when the inattentiveness warning condition is satisfied.

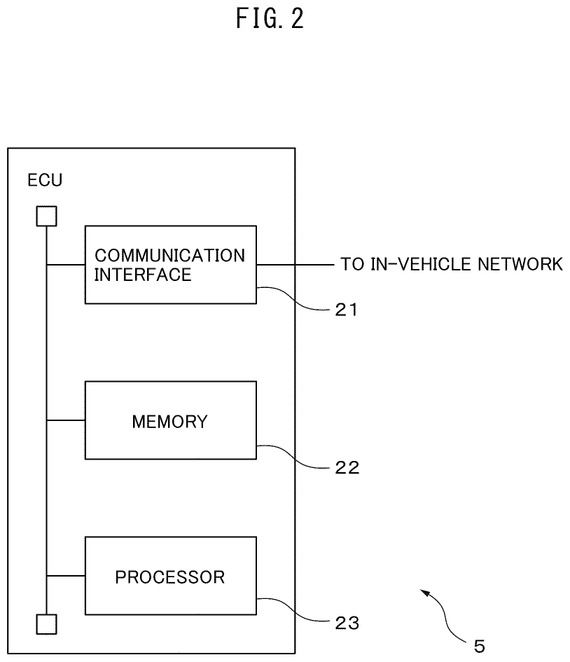

FIG. 2 illustrates the hardware configuration of the ECU 5. As illustrated in FIG. 2, the ECU 5 includes a communication interface 21, a memory 22, and a processor 23. The communication interface 21, the memory 22, and the processor 23 may each be configured as separate circuits or may be integrally configured as a single integrated circuit.

The communication interface 21 includes a interface circuit for connecting the ECU 5 to other devices in the vehicle. The communication interface 21 passes an external sensor signal or a driver image received from the external sensor 2 or the driver monitoring camera 3 via the in-vehicle network to the processor 23. The communication interface 21 outputs the notification signal received from the processor 23 to the notification device 4 via the in-vehicle network.

The memory 22 is an example of a storage unit, and includes, for example, a volatile semiconductor memory and a non-volatile semiconductor memory. The memory 22 stores various types of data used in the driver monitoring process executed by the processor 23.

The processor 23 includes one or more central processing units (CPUs) and a peripheral circuit thereof. The processor 23 may further include another operating circuit, such as a logic arithmetic unit, an arithmetic unit, or a graphics processing unit. The processor 23 executes a driver monitoring process.

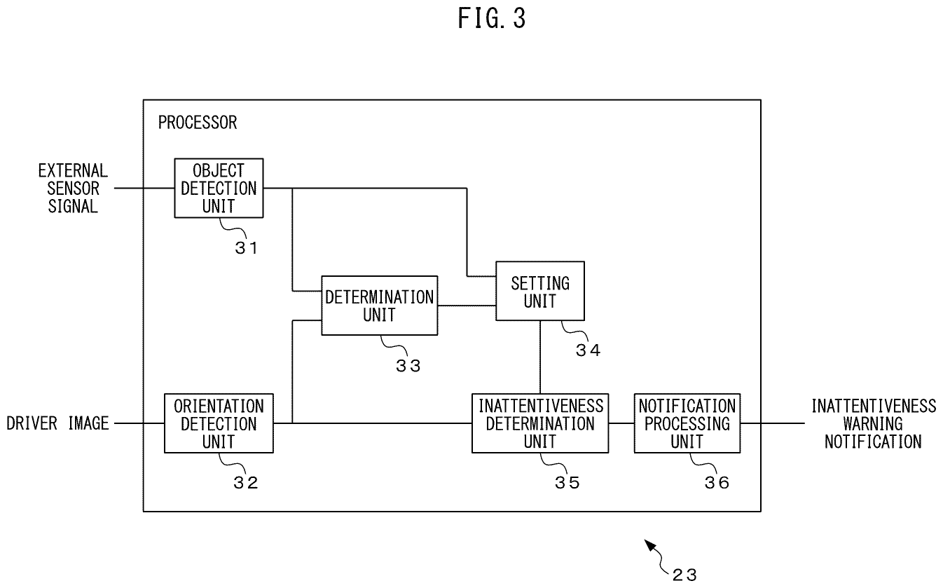

FIG. 3 is a functional block diagram of the processor 23 relating to the driver monitoring process. The processor 23 includes an object detection unit 31, an orientation detection unit 32, a determination unit 33, a setting unit 34, an inattentiveness determination unit 35, and a notification processing unit 36. Each of these units included in the processor 23 is, for example, a functional module implemented by a computer program executed by the processor 23. Alternatively, each of these units included in the processor 23 may be a dedicated operating circuit provided in the processor 23.

The object detection unit 31 detects an object having a possibility of affecting the travel of the vehicle 10 based on the outside-vehicle sensor signal generated by the external sensor 2. Objects that may affect the travel of the vehicle 10 include, for example, other vehicles that travel around the vehicle 10, such as pedestrians and motorcycles, traffic lights, and road signs such as pause signs. In addition, in the following description, an object that may affect the travel of the vehicle 10 may be referred to as a target object.

The object detection unit 31 detects a target object represented by an external sensor signal and identifies the type of the detected target object by inputting the sensor signal to a classifier learned in advance so as to detect the target object. As the classifier, a classifier based on a machine learning technique such as a deep neural network (DNN) having a convolutional neural network (CNN) type architecture, a AdaBoost, or a support vector machine is used.

Further, the object detection unit 31 specifies an azimuth from the driver of the vehicle 10 to the detected target object (hereinafter, sometimes referred to as an object direction). When the external sensor 2 is a camera, the object detection unit 31 specifies, as the object direction, an azimuth corresponding to a position of a centroid of an object region which represents the target object on an image generated by the camera, the image being an example of an external sensor signal. Although a position of the external sensor 2 and a position of the driver are not the same, a difference between the positions is sufficiently small compared to an assumed distance from the vehicle 10 to the target object. Therefore, a difference between a direction from the external sensor 2 to the target object and a direction from the driver to the target object is negligible, and the object direction is specified based on the position of the centroid of the object region. In this case, the object detection unit 31 may specify the azimuth corresponding to the position of the centroid of the object region based on the camera parameters such as the attachment position of the camera 2 with respect to the vehicle 10, the shooting direction, and the focal length. In the case where the external sensor 2 is a ranging sensor, the object detection unit 31 may specify, as the object direction, an azimuth in which the target object is detected in a ranging signal generated by the ranging sensor, the ranging signal being another example of the external sensor signal.

Furthermore, the object detection unit 31 applies a predetermined tracking method such as KLT tracking to the target object detected in each of the plurality of external sensor signals obtained in time series. Thus, the object detection unit 31 associates the same target object with each other in the plurality of external sensor signals. Further, the object detection unit 31 determines whether or not the target object that may move, such as a pedestrian, is moving based on the tracking result. For this purpose, the object detection unit 31 determines the position of the target object at the time of generation of each of the external sensor signals. The object detection unit 31 determines that the target object is moving when a movement amount between the positions is larger than a predetermined movement threshold value, and, on the other hand, determines that the target object is stationary when the movement amount is equal to or smaller than the movement threshold value. When the external sensor signal is a ranging signal, the object detection unit 31 may estimate the position of the target object based on the azimuth in which the target object is represented in the ranging signal, the distance in the azimuth thereof, and the position and the traveling direction of the vehicle 10 at the time of generating the ranging signal. Further, when the external sensor signal is an image, the object detection unit 31 may estimate the position of the target object with respect to the camera which is the external sensor 2 on the basis of the orientation from the camera corresponding to the position of the lower end of a region in which the target object is represented on the image and the installation height of the camera, assuming that the position of the lower end of the region corresponds to the position where the target object is in contact with the road surface. Then, the object detection unit 31 may estimate the position of the target object based on the position and the traveling direction of the vehicle 10 at the time of generating the image and the position of the target object with respect to the camera. As the position of the vehicle 10 at the time of generating the external sensor signal, the object detection unit 31 can use the position of the vehicle 10 measured by a satellite-positioning device mounted on the vehicle 10 mounted on the vehicle 10 such as a GPS receiver (not illustrated) at the time of generating the external sensor signal. In addition, the object detection unit 31 can use, as the traveling direction of the vehicle 10 at the time of generating the external sensor signal, the traveling direction of the vehicle 10 measured by an azimuth sensor (not illustrated) mounted on the vehicle 10 at the time of generating the external sensor signal.

The object detection unit 31 notifies the determination unit 33 of the number of detected target objects. For each of the detected target objects, the object detection unit also notifies the determination unit 33 of the type of the target object, the object direction, and the determination result of whether or not the target object is moving.

The orientation detection unit 32 detects, among an orientation of the face of the driver and a gaze direction of the driver, at least the gaze direction based on the driver image.

For example, the orientation detection unit 32 inputs a driver image to a classifier learned in advance so as to detect a driver's face from the driver image and a plurality of feature points of the face, thereby detecting a region in which the driver's face is represented on the driver image (hereinafter, referred to as a face region) and detecting a plurality of feature points of the driver's face, such as an eye corner, an eye head, an upper eyelid, a lower eyelid, a nasal tip point, and an oral angle point. As such a classifier, the orientation detector 32 may use, for example, a DNN having a CNN architecture, a support vector machine, or a AdaBoost classifier. The orientation detection unit 32 may detect the face region and the facial feature points from the driver image according to another method of detecting the face region and the facial feature points, such as template matching.

The orientation detection unit 32 fits each of the detected feature points of the face to a three-dimensional face model representing the three-dimensional shape of the face. Then, the orientation detection unit 32 detects an orientation of the face of the three-dimensional face model when each feature point is most fitted to the three-dimensional face model as the orientation of the face of the driver. The orientation detection unit 32 may detect the orientation of the face of the driver based on the driver image in accordance with another method of determining the orientation of the face represented in the image.

Further, in order to detect the gaze direction of the driver, the orientation detection unit 32 detects a corneal reflection image (hereinafter, referred to as a Purkinje image) of the light source and a centroid of the pupil (hereinafter, simply referred to as a pupil centroid) from an area surrounded by the upper eyelid and the lower eyelid (hereinafter, referred to as an eye area) for at least one of the left and right eyes of the driver represented on the driver image. For this purpose, the orientation detection unit 32 detects the Purkinje image by template matching between the template of the Purkinje image and the eye area. Similarly, the orientation detection unit 32 may detect the pupil by template matching between the template of the pupil and the eye area, and determine the centroid of the region in which the detected pupil is represented as the pupil centroid. Then, the orientation detection unit 32 determines the positional relationship between the Purkinje image and the pupil centroid, and detects the gaze direction of the driver by referring to a table representing the relationship between the positional relationship and the gaze direction of the driver. The table may be stored in advance in the memory 22.

The orientation detection unit 32 notifies the determination unit 33 and the inattentiveness determination unit 35 of the detected gaze direction of the driver. When the orientation of the driver's face is detected, the orientation detection unit 32 notifies the inattentiveness determination unit 35 of the detected orientation of the driver's face.

The determination unit 33 sets a peripheral visual range based on the latest gaze direction of the driver detected by the orientation detection unit 32. The peripheral visual range is set as an angle range corresponding to a peripheral visual field of the driver, which is set to the outer periphery of the central vision range centered on the gaze direction of the driver.

When the target object is an object that may move, such as a pedestrian, the determination unit 33 may adjust the peripheral visual range depending on whether or not the target object is moving. For example, the determination unit 33 may make the peripheral visual range in a case where the target object is moving narrower than the peripheral visual range in a case where the target object is stationary.

In addition, in a case where a plurality of target objects are detected, the determination unit 33 may determine, for each target object, whether or not the object direction with respect to the target object is included within the peripheral visual range. Further, the determination unit 33 may make the peripheral visual range in a case where a plurality of target objects are detected narrower than the peripheral visual range in a case where only one target object is detected.

Further, the determination unit 33 may limit the peripheral visual range as the speed of the vehicle 10 measured by a vehicle speed sensor (not illustrated) mounted on the vehicle 10 increases.

The determination unit 33 determines, for each detected target object, whether or not the object direction for the target object is included within the set peripheral visual range by comparing the peripheral visual range set for the target object with the object direction for the target object. Then, the determination unit 33 notifies the setting unit 34 of a determination result as to whether or not the object direction to the target object is included within the peripheral viewing range.

The setting unit 34 sets an inattentiveness warning condition for determining whether to notify an inattentiveness warning. In particular, when the object direction to the detected target object is included within the peripheral visual range, the setting unit 34 sets the inattentiveness warning condition based on the driving mode being applied to the vehicle 10.

The inattentiveness warning is issued when it is assumed that the driver is not monitoring the situation around the vehicle 10 in the traveling direction of the vehicle 10. Therefore, the inattentiveness warning condition is set such that a period in which the orientation of the face of the driver or the gaze direction of the driver deviates from a predetermined angle range centered on the front direction of the vehicle 10 continues for a predetermined time threshold or more. Therefore, as the predetermined angle range becomes narrower or the time threshold becomes shorter, the inattentiveness warning condition is relaxed and the inattentiveness warning is easily issued.

For example, when the driving mode applied to the vehicle 10 is a first driving mode in which the driver is not required to hold a steering, the setting unit 34 sets a first inattentiveness warning condition when the object direction of the target object is included within the peripheral visual range, stricter than a second inattentiveness warning condition when the object direction deviates from the peripheral visual range or when the target object is not detected. In other words, the predetermined angle range in the first inattentiveness warning condition is set to be wider than the predetermined angle range in the second inattentiveness warning condition. Alternatively, the time threshold in the first inattentiveness warning condition is set to a value greater than the time threshold in the second inattentiveness warning condition. The first operation mode may be, for example, an operation mode compliant with autonomous driving level 2 defined by Society of Automotive Engineers (SAE).

When the object direction of the target object is included within the peripheral visual range, there is a possibility that the driver views the target object in the peripheral visual field. Therefore, by setting the first inattentiveness warning condition as described above, it is difficult to notify the inattentiveness warning when the driver is visually recognizing the target object, and it is suppressed that the driver feels troublesomeness.

Further, when the driving mode applied to the vehicle 10 is a second driving mode in which the driver is required to hold a steering, the setting unit 34 makes a third inattentiveness warning condition when the object direction of the target object is included within the peripheral visual range more relaxed than the second inattentiveness warning condition. In other words, the predetermined angle range in the third inattentiveness warning condition is set to be narrower than the predetermined angle range in the second inattentiveness warning condition.

Alternatively, the time threshold in the third inattentiveness warning condition is set to a value smaller than the time threshold in the second inattentiveness warning condition. It should be noted that the second driving mode may be a driving mode compliant with autonomous driving level 0 or level 1 defined by SAE, for example, a driving mode to which adaptive cruise control or lane tracing assist is applied.

In this case, an inattentiveness warning is easily issued only when the driver views the target object in the peripheral visual field, so that the driver can be guided to view the target object in the central visual field.

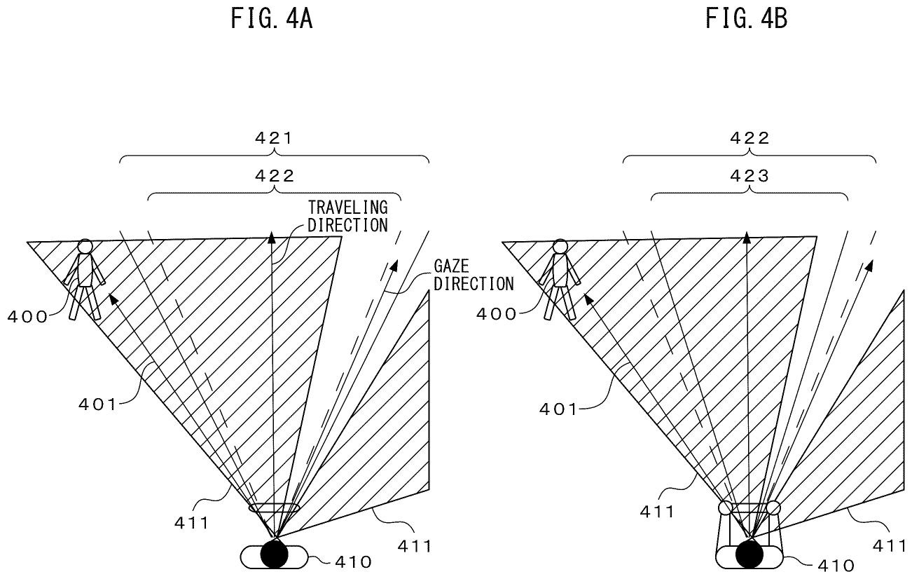

FIGS. 4A and 4B illustrate an example of an inattentiveness warning condition, respectively. In the embodiment illustrated in FIG. 4A, the first operation mode in which the driver is not required to hold a steering is applied. The object direction 401 to the pedestrian 400, which is the target object, is included within the peripheral visual range 411 set based on the gaze direction of the driver 410. Therefore, the angle range 421, which includes the traveling direction of the vehicle 10 and is not determined to be inattentiveness, is set to be wider than the angle range 422 when a target object such as the pedestrian 400 is not detected. This makes it difficult to notify an inattentiveness warning.

Also in the embodiment illustrated in FIG. 4B, the object orientation 401 to the pedestrian 400, which is the target object, is included within the peripheral visual range 411 of the drivers 410. However, in this example, the second operation mode in which the driver is required to hold a steering is applied. Therefore, the angle range 423 that is not determined to be inattentiveness is set to be narrower than the angle range 422 when the target object is not detected. As a result, the inattentiveness warning is easily issued.

Further, the setting unit 34 may set the inattentiveness warning condition based on the situation around the vehicle 10. For example, the setting unit 34 may adjust the inattentiveness warning condition according to whether or not the detected target object is moving or the number of detected target objects. In this case, the setting unit 34 may make the first inattentiveness warning condition in the case where the target object is stationary stricter than the first inattentiveness warning condition in the case where the target object is moving. Thus, if the target object is moving, the driver is easily issued of the inattentiveness warning even if the driver is visually recognizing the target object in the peripheral visual field. Therefore, the propriety of the notification of the inattentiveness warning is determined more appropriately. However, it is preferable that the first inattentiveness warning condition in the case where the target object is moving is stricter than the second inattentiveness warning condition. Similarly, the setting unit 34 may make the third inattentiveness warning condition in a case where the target object is moving, more relaxed than the third inattentiveness warning condition in a case where the target object is stationary. However, it is preferable that the third inattentiveness warning condition in the case where the target object is stationary is more relaxed than the second inattentiveness warning condition.

Furthermore, the setting unit 34 may make the first inattentiveness warning condition in a case where a plurality of target objects are detected more relaxed than the first inattentiveness warning condition in a case where the detected target object is one. However, it is preferable that the first inattentiveness warning condition in a case where a plurality of target objects are detected is stricter than the second inattentiveness warning condition. Similarly, the setting unit 34 may make the third inattentiveness warning condition in a case where a plurality of target objects are detected more relaxed than the third inattentiveness warning condition in a case where the detected target object is one. However, it is preferable that the third inattentiveness warning condition in the case where the detected target object is one is more relaxed than the second inattentiveness warning condition. In a case where a plurality of target objects are detected, if the object direction of at least one target object is included within the peripheral visual range, the setting unit 34 may apply the first inattentiveness warning condition or the third inattentiveness warning condition.

Further, the setting unit 34 may make the second inattentiveness warning condition when the driving mode applied to the vehicle 10 is the second driving mode stricter than the second inattentiveness warning condition when the driving mode applied to the vehicle 10 is the first driving mode. For example, the setting unit 34 sets the time threshold in the second inattentiveness warning condition when the driving mode applied to the vehicle 10 is the second driving mode to a value larger than the time threshold in the second inattentiveness warning condition when the driving mode applied to the vehicle 10 is the first driving mode. Thus, the troublesomeness of the driver is further reduced when the second operation mode is applied.

The setting unit 34 notifies the inattentiveness determination unit 35 of the set inattentiveness warning condition.

The inattentiveness determination unit 35 determines whether or not the orientation of the face of the driver or the gaze direction of the driver satisfies the inattentiveness warning condition. As described above, the inattentiveness determination unit 35 determines that the inattentiveness warning condition is satisfied when a period in which the detected one of the orientation of the face or the gaze direction is deviated from a predetermined angle range centered on the front direction of the vehicle 10, is longer than a predetermined time threshold.

The inattentiveness determination unit 35 notifies the notification processing unit 36 of the determination result as to whether or not the inattentiveness warning condition is satisfied.

When the determination result that the inattentiveness warning condition is satisfied is received from the inattentiveness determination unit 35, the notification processing unit 36 notifies the driver of the inattentiveness warning via the notification device 4. For example, the notification processing unit 36 causes the speaker included in the notification device 4 to utter an audio signal or a warning sound that warns the driver of inattentiveness. Alternatively, the notification processing unit 36 causes the display device included in the notification device 4 to display a warning message or icon that warns of inattentiveness. Alternatively, the notification processing unit 36 vibrates the vibrator included in the notification device 4, or turns on or blinks the light source included in the notification device 4.

After notifying the driver of the inattentiveness warning via the notification device 4, the notification processing unit 36 stops the notification of the inattentiveness warning when the determination result that the inattentiveness warning condition is no longer satisfied is received from the inattentiveness determination unit 35.

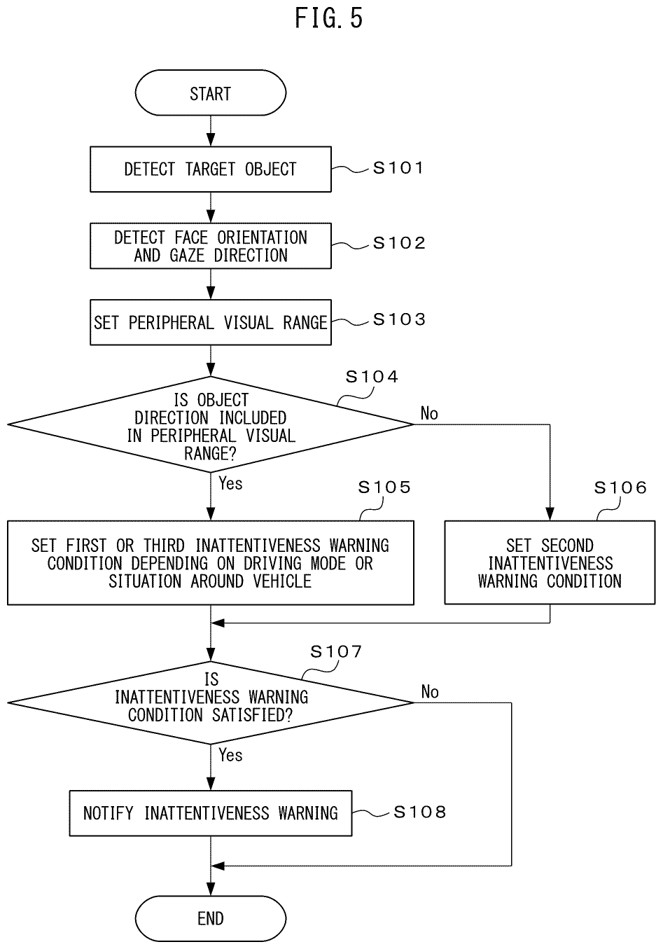

FIG. 5 is an operation flowchart of the driver monitoring process executed by the processor 23. The object detection unit 31 detects a target object based on an external sensor signal generated by the external sensor 2 (step S101). The orientation detection unit 32 detects, among an orientation of a face of a driver and a gaze direction of the driver, at least the gaze direction based on a driver image generated by the driver monitoring camera 3 (step S102).

The determination unit 33 sets a peripheral visual range based on the detected gaze direction of the driver (step S103). Then, the determination unit 33 determines whether or not the object direction to the target object is included within the peripheral visual range (step S104).

When the object direction to the target object is included within the peripheral visual range (step S104—Yes), the setting unit 34 sets a first or third inattentiveness warning condition according to the driving mode applied to the vehicle 10 or the situation around the vehicle 10 (step S105). On the other hand, when the object direction to the target object is not included within the peripheral visual range (step S104—No), the setting unit 34 sets a second inattentiveness warning condition (step S106).

The inattentiveness determination unit 35 determines whether or not the orientation of the driver's face or the gaze direction of the driver satisfies the set inattentiveness warning condition (step S107). When the inattentiveness warning condition is satisfied (step S107—Yes), the notification processing unit 36 notifies the driver of the inattentiveness warning via the notification device 4 (step S108).

After the step S108 or when the inattentiveness alert condition is not satisfied in the step S107 (step S107—No), the processor 23 ends the driver monitoring process.

As described above, the driver monitoring device adjusts the inattentiveness warning condition in the case where the detected target object is included within the peripheral visual field of the driver in accordance with the driving mode or the like, and therefore can appropriately execute the inattentiveness warning to the driver so that the driver does not feel troublesomeness.

Even after a first grace period has elapsed from starting of the notification of the inattentiveness warning, when the state in which the inattentiveness warning condition is satisfied continues, the notification processing unit 36 may increase the intensity of the warning. For example, the notification processing unit 36 may increase the sound of the inattentiveness warning outputted from the speaker. Alternatively, the notification processing unit 36 may increase the number of devices that notify the inattentiveness warning. Further, when the state in which the inattentiveness warning condition is satisfied continues even after a second grace period longer than the first grace period has elapsed from starting of the notification of the inattentiveness warning, the processor 23 may control each unit of the vehicle 10 to decelerate or stop the vehicle 10.

Further, it is assumed that the more the same target object remains in the peripheral visual field of the driver, the more likely the driver views the target object in the peripheral visual field. Therefore, the setting unit 34 may adjust the inattentiveness warning condition so as to make the inattentiveness warning condition stricter as a period in which the object direction to the same target object is included within the peripheral visual range becomes longer. Alternatively, the setting unit 34 may adjust the inattentiveness warning condition so as to make the inattentiveness warning condition stricter when the period exceeds a predetermined switching threshold.

According to another modification, the setting unit 34 may make the inattentiveness warning condition stricter as the lateral distance from the vehicle 10 to the end of the road area where the vehicle 10 can travel is longer. In this case, the setting unit 34 may determine the lateral distance by referring to the current position of the vehicle 10 measured by a satellite positioning device (not illustrated) mounted on the vehicle 10 and a high-precision map including information on the road width of each road. Alternatively, the setting unit 34 may estimate the current position of the vehicle 10 by matching an image around the vehicle 10 generated by a camera, which is an example of the external sensor 2, with the high-precision map, and determine the lateral distance based on the estimated position.

The computer program for implementing the driver monitoring process according to the above-described embodiment or modification may be provided in a form recorded on a computer-readable portable recording medium.

As described above, a skilled person can make various modifications according to the embodiment within the scope of the present invention.

What is claimed is:

1. A driver monitoring device comprising:
a processor configured to:
detect an object having a possibility of affecting traveling of a vehicle based on an external sensor signal representing a situation around the vehicle,
detect, among a gaze direction of a driver of the vehicle and an orientation of a face of the driver, at least the gaze direction based on a driver image representing the driver,
determine whether or not an object direction to the detected object is included within a peripheral visual range corresponding to a peripheral visual field of the driver based on the gaze direction,
set an inattentiveness warning condition when the object direction is included within the peripheral visual range based on a driving mode being applied to the vehicle or the situation around the vehicle, and
notify the driver of an inattentiveness warning via a notification device when at least detected one of the orientation of the face of the driver and the gaze direction of the driver satisfies the inattentiveness warning condition.

2. The driver monitoring device according to claim 1, wherein the processor sets the inattentiveness warning condition in a case where the driving mode is set to a first driving mode in which the driver is not required to hold a steering, to be stricter than the inattentiveness warning condition in a case where the driving mode is set to a second driving mode in which the driver is required to hold the steering.

3. The driver monitoring device according to claim 1, wherein,
in the case where the driving mode is set to a first driving mode in which the driver is not required to hold a steering, the processor sets the inattentiveness warning condition when the object direction is included within the peripheral visual range stricter than the inattentiveness warning condition when the object direction is not included within the peripheral visual range.

4. The driver monitoring device according to claim 1, wherein the processor is further configured to determine whether or not the detected object is moving, and
the processor sets the inattentiveness warning condition when the detected object is stationary stricter than the inattentiveness warning condition when the detected object is moving, in a case where the driving mode is set to a first driving mode in which the driver is not required to hold a steering and the object direction is included within the peripheral visual range.

5. A driver monitoring method comprising:
detecting an object having a possibility of affecting traveling of a vehicle based on an external sensor signal representing a situation around the vehicle;
detecting, among a gaze direction of a driver of the vehicle and an orientation of a face of the driver, at least the gaze direction based on a driver image representing the driver;
determining whether or not an object direction to the detected object is included within a peripheral visual range corresponding to a peripheral visual field of the driver based on the gaze direction;
setting an inattentiveness warning condition when the object direction is included within the peripheral visual range based on a driving mode being applied to the vehicle or the situation around the vehicle; and
notifying the driver of an inattentive warning via a notification device when at least a detected one of the orientation of the face of the driver and the gaze direction satisfies the inattentiveness warning condition.

6. A non-transitory recording medium that stores a driver monitoring computer program for causing a processor mounted on the vehicle to execute the process comprising:
detecting an object having a possibility of affecting traveling of a vehicle based on an external sensor signal representing a situation around the vehicle;
detecting, among a gaze direction of a driver of the vehicle and an orientation of a face of the driver, at least the gaze direction based on a driver image representing the driver;
determining whether or not an object direction to the detected object is included within a peripheral visual range corresponding to a peripheral visual field of the driver based on the gaze direction;
setting an inattentiveness warning condition when the object direction is included within the peripheral visual range based on a driving mode being applied to the vehicle or the situation around the vehicle; and
notifying the driver of an inattentiveness warning via a notification device when at least detected one of the orientation of the face of the driver and the gaze direction of the driver satisfies the inattentiveness warning condition.
